(19) United States
(12) Patent Application Publication
(10) Pub. No.: US 2024/0166844 A1
(43) Pub. Date: May 23, 2024

(54) RESIN COMPOSITION AND USE THEREOF

(71) Applicant: NAN YA PLASTICS CORPORATION, TAIPEI (TW)

(72) Inventors: Te-Chao Liao, Taipei (TW); Hung-Yi Chang, Taipei (TW); Chia-Lin Liu, Taipei (TW); Wei-Ru Huang, Taipei (TW)

(73) Assignee: NAN YA PLASTICS CORPORATION, TAIPEI (TW)

(21) Appl. No.: 18/184,698

(22) Filed: Mar. 16, 2023

(30) Foreign Application Priority Data
Nov. 15, 2022 (TW) 111143478

(51) Int. Cl. C08K 3/22; C08K 5/5419

(52) U.S. Cl. CPC C08K 3/22; C08K 5/5419; C08K 2003/2237

(57) ABSTRACT

A resin composition and use thereof, wherein the resin composition includes a resin base, an inorganic filler and a siloxane coupling agent. The resin base includes bismaleimide resins, benzoxazine resins, and naphthenic epoxy resins, and the inorganic filler includes strontium titanate or calcium-doped strontium titanate.

### CROSS-REFERENCE TO RELATED APPLICATION

This application claims the priority benefit of Taiwan application serial no. 111143478, filed on Nov. 15, 2022. The entirety of the above-mentioned patent application is hereby incorporated by reference herein and made a part of this specification.

### BACKGROUND

### Technical Field

The present invention is about a kind of resin composition, and especially about a kind of resin composition with high dielectric constant (high-k) and its use.

### Description of Related Art

In the 5G/B5G communication era, circuit substrates are increasingly miniaturized. In order to increase the insulation between circuit lines and reduce the power consumption of circuit line transmission, the development of resin composition with high dielectric constant (Dk) as a substrate material is an urgent goal in the industry.

### SUMMARY

The present invention provides a resin composition and its use. The resin composition can be used as a substrate material for 5G high frequency, and has high-k characteristics while maintaining the heat resistance of the substrate produced therefrom.

A resin composition of the present invention includes a resin base, an inorganic filler and a siloxane coupling agent. The resin base includes a bismaleimide resin, a benzoxazine resin, and a naphthalene epoxy resin. The inorganic filler includes strontium titanate or calcium doped strontium titanate.

In an embodiment of the present invention, the aforementioned calcium-doped strontium titanate is represented by SrₓCa_{y}TiO₃, x is between 0.05 and 0.4, and y is between 0.6 and 0.95.

In an embodiment of the present invention, based on the total weight of the resin base, the aforementioned bismaleimide resin is between 10% by weight and 70% by weight, and the benzoxazine resin is between 10% by weight to 50% by weight, and the naphthalene epoxy resin is between 10% by weight and 50% by weight.

In an embodiment of the present invention, the structure of the aforementioned bismaleimide resin is represented in formula (I):

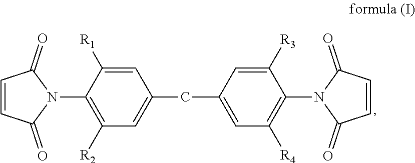

wherein, each of R₁, R₂, R₃ and R₄ is independently an alkyl having a carbon number of 1 to 5, and C is one selected from biphenyl, naphthalene ring and bisphenol A.

In an embodiment of the present invention, the aforementioned R₁ and R₃ are methyl, and R₂ and R₄ are ethyl.

In an embodiment of the present invention, the aforementioned bismaleimide resin includes at least one of a bismaleimide resin purchased from Daiwakasei Industry with the trade name BMI-5000, a bismaleimide resin purchased from Daiwakasei Industry with a trade name BMI-2300, a bismaleimide resin purchased from Nippon Kayaku with the trade name MIR-3000 and a bismaleimide resin purchased from Nippon Kayaku with the trade name MIR-5000.

In an embodiment of the present invention, the structure of the aforementioned naphthalene epoxy resin is represented in formula (II):

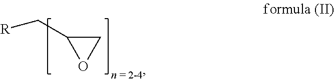

wherein R is a naphthalene ring derivative or a binaphthyl derivative.

In an embodiment of the present invention, the aforementioned naphthalene epoxy resin may include but not limited to at least one of a naphthalene epoxy resin purchased from Japan DIC with the trade name HP-4710, a naphthalene epoxy resin purchased from Japan DIC with the trade name HP-6000 and a naphthalene epoxy resin purchased from Japan DIC with the trade name HP-9500.

In an embodiment of the present invention, based on 100 parts by weight of the resin composition, an amount of the aforementioned inorganic filler added is between 100 parts by weight and 300 parts by weight.

In an embodiment of the present invention, based on 100 parts by weight of the resin base, an amount of the aforementioned siloxane coupling agent added is between 0.1 parts by weight to 4 parts by weight.

In an embodiment of the present invention, the aforementioned resin composition further includes a hardener. Based on 100 parts by weight of the resin base, an amount of the hardener added is between 0 part by weight and 30 parts by weight.

In an embodiment of the present invention, the aforementioned hardener includes at least one of a hardener purchased from Eumate with the trade name S-1817, a hardener purchased from WACKER with the trade name HP-2000, and a hardener purchased from SIGMA with the trade name DDS.

In an embodiment of the present invention, the aforementioned resin composition further includes a catalyst. Based on 100 parts by weight of the resin base, an amount of the catalyst added is between 0 part by weight and 10 parts by weight.

A use of the aforementioned resin composition of the present invention as a substrate, wherein a dielectric constant of the substrate is greater than or equal to 9.

Based on the above, the resin composition of the present invention can improve the dielectric constant of the material and maintain the heat resistance by introducing the inorganic filler of strontium titanate or calcium-doped strontium titanate, so that it can be more suitable for being as a substrate material for 5G high frequency, and while maintaining a good heat resistance of the substrate produced from it, a high-k characteristics is also obtained.

### DESCRIPTION OF THE EMBODIMENTS

Hereinafter, the embodiment of the present invention will be described in detail. However, these embodiments are exemplary and the present invention disclosure is not limited thereto.

Herein, a range indicated by “one value to another value” is a general representation which avoids enumerating all values in the range in the specification. Therefore, the description of a specific numerical range covers any numerical value in the numerical range and the smaller numerical range defined by any numerical value in the numerical range, as if the arbitrary numerical value and the smaller numerical range are written in the specification.

In present invention, a resin composition can include a resin base, an inorganic filler and a siloxane coupling agent. In addition, in some embodiments, the resin composition may further include a hardener and/or a catalyst. Hereinafter, the above-mentioned various components will be described in detail.

### <Resin Base>

In this embodiment, the resin base includes, for example, a bismaleimide (BMI) resin, a benzoxazine resin, and a naphthalene epoxy resin. In some embodiments, the bismaleimide resin may include, but not limited to, at least one of a bismaleimide resin purchased from Daiwakaisei Industry with the trade name BMI-5000, a bismaleimide resin purchased from Daiwakaisei Industry with the trade name BMI-2300, a bismaleimide resin purchased from Nippon Kayaku with the trade name MIR-3000, and a bismaleimide resin purchased from Nippon Kayaku with the trade name MIR-5000. The structure of the bismaleimide resin can be represented in formula (I):

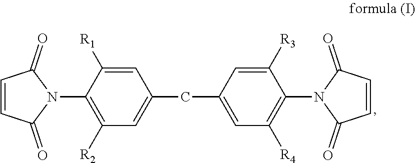

wherein each of R₁, R₂, R₃ and R₄ is independently an alkyl having a carbon number of 1 to 5, and C is one selected from biphenyl, naphthalene ring and bisphenol A. In some embodiments, R₁ and R₃ are methyl, and R₂ and R₄ are ethyl.

In some embodiments, the benzoxazine resin may include, but not limited to, a benzoxazine resin purchased from Kuen Bong with the trade name KB-610. In some embodiments, the naphthalene epoxy resin may include, but not limited to, at least one of a naphthalene epoxy resin purchased from Japan DIC with the trade name HP-4710, a naphthalene epoxy resin purchased from Japan DIC with the trade name HP-6000 and a naphthalene epoxy resin purchased from Japan DIC with the trade name HP-9500. A structure of the naphthalene epoxy resin can be represented in formula (II):

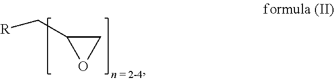

wherein R can be a naphthalene ring derivative or a binaphthyl derivative.

In this embodiment, based on a total weight of the resin base as 100 parts by weight, the bismaleimide resin is about between 10% by weight to 70% by weight, the benzoxazine resin is about between 10% by weight to 50% by weight, and the naphthalene epoxy resin is about between 10% by weight and 50% by weight. In some preferred embodiments, the bismaleimide resin in the resin base can be about between 20% by weight and 70% by weight, the benzoxazine resin can be about between 0% by weight and 30% by weight, and the naphthalene epoxy resin can be about between 20% by weight and 80% by weight. When the components and proportions in the resin base fall within the range defined above, the resin composition would have the advantages of high cross-linking degree and stable heat resistance.

### <Inorganic Filler>

In this embodiment, the inorganic filler may include strontium titanate (SrTiO₃) or calcium-doped strontium titanate (Ca-doped SrTiO₃) The calcium-doped strontium titanate can be expressed as SrₓCa_{y}TiO₃. In some preferred embodiments, x is between 0.05 and 0.4, and y is between 0.6 and 0.95, but the present invention is not limited thereto. Generally speaking, known inorganic fillers added to the resin composition are, for example, silicon dioxide (SiO₂), aluminum oxide (Al₂O₃), aluminum hydroxide (Al(OH)₃), calcium carbonate (CaCO₃) and etc. These inorganic fillers are related to the fluidity and the thermal expansion of the resin composition, or to the mechanical strength and the dimensional stability of the resin composition after hardening, and also affect the electrical performance of subsequent products (such as circuit substrate). In the present invention, by introducing strontium titanate or calcium-doped strontium titanate as the inorganic filler, it can help to increase the dielectric constant of the resin composition and maintain the heat resistance, so that the resin composition is more suitable for being as a substrate material for 5G high frequency, and high-k (Dk) properties are obtained, while maintaining a good heat resistance of the substrate produced by it.

In detail, in some embodiments, based on a total weight of the resin composition, an amount of the inorganic filler (i.e. strontium titanate (SrTiO₃) or calcium-doped strontium titanate (Ca-doped SrTiO₃)) added can be between about 100 parts by weight and 300 parts by weight. In some preferred embodiments, the amount of the inorganic filler added may range from about 150 parts by weight to 300 parts by weight. Compared with the commonly used silicon dioxide (SiO₂) or aluminum oxide (Al₂O₃), the strontium titanate or calcium-doped strontium titanate of the present invention, through its spherical shape, an appropriate particle size (D50 is about 0.5 micrometers, D90 is about 45 micronmeters), an appropriate ratio and etc., can improve the density of the arrangement and easily form stacks, so as to effectively achieve the densest packing, and thus the effect of raising dielectric constant (Dk) is improved while maintaining good heat resistance; moreover, since strontium titanate and calcium-doped strontium titanate have a property of high dipole moment, they can achieve the electrical characteristics of high Dk. In addition, in some embodiments, calcium doped strontium titanate (Ca-doped SrTiO₃) as the inorganic filler of the resin composition may increase the dielectric constant of the resin composition more effectively than strontium titanate (SrTiO₃). At the same time, it can also effectively reduce the dielectric loss (DO to achieve the electrical specifications of high dielectrics.

### <Siloxane Coupling Agent>

In the present invention, the resin composition includes siloxane coupling agent. Siloxane coupling agent can be used to improve the bonding performance of the material, for example, it can improve the adhesion between the substrate and the copper foil. Based on 100 parts by weight of the resin base, an amount of the siloxane coupling agent added may range from about 0.1 parts by weight to 4 parts by weight. In some preferred embodiments, the amount of siloxane coupling agent added may be between about 0.2 parts by weight and 3 parts by weight. When the amount of siloxane coupling agent added is less than 0.1 parts by weight or more than 4 parts by weight, the van der Waals force or the chemical bond between the material and the copper foil may not be enough or the bonding force may be too high, which will affect the overall fluidity and its application scope. When the amount of the siloxane coupling agent added is between 1 part by weight and 2 parts by weight, it can have a relatively suitable bonding performance (that is, the material has reasonable fluidity and applicability). In the embodiment of the present invention, the siloxane coupling agent may include but not limited to siloxane. In addition, according to the types of functional groups, siloxane can be divided into amino silane, epoxide silane, vinyl silane, ester silane, hydroxyl silane, isocyanate silane, methacryloxysilane and acryloxysilane. In this embodiment, the siloxane coupling agent may include, but not limited to, a siloxane coupling agent purchased from Dow Corning with the trade name Z6030.

### <Hardener>

In this embodiment, the resin composition further includes a hardener. The hardener can chemically react with the main resin to achieve the purpose of cross-linking and hardening to form a thermosetting resin product. Specifically, the hardener may include, but not limited to, primary amines and secondary amines, such as 3,3′-diaminodiphenyl sulfone (DDS), 4,4′-methylenedianiline (MDA), p-aminophenol, and the like. In some embodiments, based on 100 parts by weight of the resin base, an amount of the hardener added is about 0 to 30 parts by weight. When the amount of hardener added is greater than 30 parts by weight, it may affect the fluidity of the resin composition, resulting in early hardening, and thus there will be gaps between the finished product (such as a circuit substrate) and the circuits, which will affect the overall performances. In addition, in some embodiments, the hardener includes at least one of a hardener purchased from Eumate with a trade name S-1817 (primary amine), a hardener purchased from WACKER with a trade name HP-2000 (with amine functional groups) and 3,3′-diaminodiphenyl sulfone hardener purchased from SIGMA with a trade name DDS.

### <Catalyst>

In this embodiment, in order to improve the system reactivity, the resin composition further includes a catalyst. The catalyst can be, for example but not limited to, imidazole and phosphonium borate. Further, the catalyst includes 1-cyanoethyl-2-phenylimidazole (2PZCN; CAS: 23996-12-5), 1-benzyl-2-phenylimidazole (1B2PZ; CAS: 37734-89-7), thiabendazole (TBZ; CAS: 7724-48-3) or a combination of the above. In some embodiments, based on 100 parts by weight of the resin base, an amount of the catalyst added is between 0 part by weight and 10 parts by weight. Preferably, the catalyst is added in an amount ranging from 0.01 parts by weight to 3 parts by weight. When the amount of catalyst added is too much, the reaction rate will be too fast, resulting in the phenomena of reduced fluidity, abnormal glue filling, lack of glue and etc. In this embodiment, the catalyst can be, for example, a phosphonium borate with the trade name TPP-MK of Hokko Chemical.

The following examples and comparative examples are given to illustrate the effects of the present invention, but the scope of rights of the present invention is not limited to the scope of the embodiment.

### Experimental Examples

The copper foil substrates produced in each example and comparative example were evaluated according to the following method.

### <Preparation of Resin Composition>

The resin composition shown in Table 1 was mixed with toluene to form a varnish of a thermosetting resin composition. The Nanya glass fabrics (Nanya Plastic Company, cloth type 2013) was impregnated with above varnish at room temperature, then dried at 130° C. (impregnated machine) for a few minutes and after that prepregs with a resin content of 60 wt % (weight percentage) were obtained. Finally, 4 pieces of the prepreg were stacked between two pieces of copper foil with a thickness of 35 μm, keeping a constant temperature for 20 minutes under a pressure of 25 kg/cm² and a temperature of 85° C., then the temperature was heated up to 185° C. at a heating rate of 3° C./min, and kept at a constant temperature for 120 minutes, and then slowly cooled down to 130° C. to obtain a copper foil substrate with a thickness of 0.5 mm.

### <Evaluation Methods and Results>

Heat resistance: 288° C. solder heat resistance (seconds): The sample was heated in a pressure cooker at 120° C. and 2 atmospheres (atm) for 120 minutes, then immersed in a 288° C. soldering machine, and the time required for the sample to burst and delaminate was recorded.

Glass transition temperature (° C.): Test by a dynamic mechanical analyzer (DMA).

Dielectric constant Dk: The dielectric constant Dk at a frequency of 10 GHz was tested by a dielectric analyzer by Agilent, model E4991A.

Dielectric loss Df: The dielectric loss Df at a frequency of 10 GHz was tested by a dielectric analyzer by Agilent, model E4991A.

Copper foil peel strength (Lb/in): The peel strength between the copper foil and the circuit carrier was tested.

TABLE 1

| | | Comparative | Comparative | Example | Example |
|---|---|---|---|---|---|
| Formulation (parts by weight) | | example 1 | example 2 | 1 | 2 |
| A. resin base | Bismaleimide resin | 50 | 50 | 50 | 50 |
| (The total | Benzoxazine resin | 20 | 20 | 20 | 20 |
| weight is 100 | Naphthalene epoxy | 30 | 30 | 30 | 30 |
| parts by | resin | | | | |
| weight) | | | | | |
| B. other | Hardener | 3.5 | 3.5 | 3.5 | 3.5 |
| additives | Siloxane coupling | 1.7 | 1.7 | 1.7 | 1.7 |
| (based on 100 | agent | | | | |
| parts by | Catalyst | 0.05 | 0.05 | 0.05 | 0.05 |
| weight of the | | | | | |
| resin base | | | | | |
| (A)) | | | | | |
| C. inorganic | calcium-doped | | | 233 | |
| filler | strontium titanate | | | | |
| (based on 100 | strontium titanate | | | | 233 |
| parts by | silicon dioxide | 233 | | | |
| weight of | aluminum oxide | | 233 | | |
| (A + B + C)) | | | | | |
| Performance | Heat resistance | pass | pass | pass | pass |
| test | (PCT 2 hours) | | | | |
| | Glass transition | 298 | 300 | 325 | 330 |
| | temperature (° C.) | | | | |
| | 10 G Dielectric | 6 | 5 | 10 | 9 |
| | constant (Dk) | | | | |
| | 10 G Dielectric loss | 0.0088 | 0.0088 | 0.0010 | 0.0095 |
| | (Df) | | | | |
| | peel strength | 6 | 5 | 6..9 | 5.8 |
| | (Lb/in) | | | | |

Formulation Information in Table 1:
Bismaleimide resin: BMI-2300
Benzoxazine resin: KB-610
Naphthalene epoxy resin: HP-4710
Hardener: S-1817
Siloxane coupling agent: Z6030
Catalyst: TPP-MK

It can be seen from Table 1 that compared with the use of silicon dioxide (Comparative example 1) or aluminum oxide (Comparative example 2), the resin composition introduces strontium titanate (Example 2) or calcium-doped strontium titanate (Example 1) as the inorganic filler are beneficial to increase the dielectric constant of the material and maintain the heat resistance without affecting its peel strength and glass transition temperature. In addition, compared with strontium titanate as the inorganic filler of resin composition (Example 2), the resin composition with the calcium-doped strontium titanate (Example 1) may have a better effect on improving the dielectric constant of the resin composition, and can also effectively reduce the dielectric loss (Df) effect.

Based on the above, the resin composition of the present invention can help improve dielectric constant by selecting strontium titanate or calcium-doped strontium titanate as an inorganic filler. In this way, it can be used as a substrate material for 5G high frequency, and obtain high-k characteristics while maintaining the good heat resistance of the substrate it produces.

Although the present invention has been disclosed above as an embodiment, it is not intended to limit the present invention. Anyone with ordinary knowledge in the technical field may make some changes and modifications without departing from the spirit and scope of the present invention. Therefore, the scope of protection of the present invention shall prevail as defined by the scope of the appended patent application.

What is claimed is:

1. A resin composition, comprising:
a resin base comprising a bismaleimide resin, a benzoxazine resin and a naphthalene epoxy resin;
an inorganic filler comprising strontium titanate or calcium-doped strontium titanate; and
a siloxane coupling agent.

2. The resin composition according to claim 1, wherein the calcium-doped strontium titanate is represented by SrₓCa_{y}TiO₃, x is between 0.05 and 0.4, and y is between 0.6 and 0.95.

3. The resin composition according to claim 1, wherein based on a total weight of the resin base, the bismaleimide resin is between 10% by weight and 70% by weight, the benzoxazine resin is between 10% by weight and 50% by weight, and the naphthalene epoxy resin is between 10% by weight and 50% by weight.

4. The resin composition according to claim 1, wherein a structure of the bismaleimide resin is represented by formula (I): 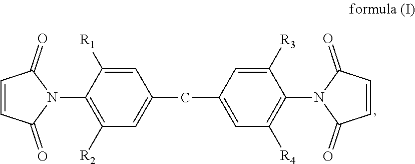
wherein, each of R₁, R₂, R₃ and R₄ is independently an alkyl having a carbon number of 1 to 5, and C is one selected from biphenyl, naphthalene ring and bisphenol A.

5. The resin composition according to claim 4, wherein R₁ and R₃ are methyl, and R₂ and R₄ are ethyl.

6. The resin composition according to claim 1, wherein a structure of the naphthalene epoxy resin is represented by formula (II): 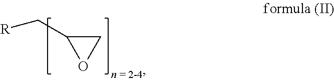
wherein R is a naphthalene ring derivative or a binaphthyl derivative.

7. The resin composition according to claim 1, wherein based on a total weight of the resin composition being 100 parts by weight, an amount of the inorganic filler added is between 100 parts by weight and 300 parts by weight.

8. The resin composition according to claim 1, wherein based on a total weight of the resin base being 100 parts by weight, an amount of the siloxane coupling agent added is between 0.1 parts by weight and 4 parts by weight.

9. The resin composition according to claim 1, further comprising a hardener, wherein based on a total weight of the resin base being 100 parts by weight, an amount of the hardener added is between 0 part by weight and 30 parts by weight.

10. The resin composition according to claim 9, wherein the hardener comprises a primary amine compound or a secondary amine compound.

11. The resin composition according to claim 1, further comprising a catalyst, wherein based on a total weight of the resin base being 100 parts by weight, an amount of the catalyst added is between 0 part by weight and 10 parts by weight.

12. A use of the resin composition according to claim 1 as a substrate, wherein a dielectric constant of the substrate is greater than or equal to 9.
